(19) United States
(12) Patent Application Publication
(10) Pub. No.: US 2007/0194262 A1
(43) Pub. Date: Aug. 23, 2007

(54) Faucet connection

(76) Inventor: Scott P. Crossley, Surrey (GB)

Correspondence Address: Galasso & Associates, LP, P. O. Box 26503, Austin, TX, 78755-0503, US

(21) Appl. No.: 11/357,643

(22) Filed: Feb. 17, 2006

(51) Int. Cl. F16L 29/00

(52) U.S. Cl. 251/148

(57) ABSTRACT

The faucet connection is designed to allow a faucet to be replaced without having to tear into a wall. By using the tap sleeve to connect the sleeve to the faucet the faucet can be easily replaced. The tap sleeve connects to the faucet by way of female threads located on the inner side. O-rings are then placed on the tap sleeve along ridges located on the tap sleeve and the tap sleeve is inserted into the sleeve. The o-rings then function to seal the tap sleeve and the sleeve preventing leaks. The tap sleeve is held in place by using grub screws which are inserted into the sleeve and engage with the tap sleeve.

### FIELD OF THE DISCLOSURE

A means of connecting a water line to the faucet with a tap that is easily installed and removed.

### BACKGROUND

There are a number of reasons why people change out faucets. As faucets grow old they can tend to rust or loose their shiny protective coating. Sometimes, people just like to change the faucet out for a different or updated look, other want to change a faucet because it has started to leak or because they are changing the counter top which requires certain widths or types of faucets to fit the designated openings for the particular counter top. Whatever the reason for changing a faucet, the easier it is to change the better.

Depending upon the set up in a particular place where you want to change out a faucet, it can be very difficult to change it. The typical faucet connection comprises a threaded bolt on the faucet wherein the bolt receives a nut which tightens causing the faucet to seal tightly up against a faucet mount or wall wherein the on/off knobs are located. In the instance of the connections being behind a wall, then the connections would seal up against a face plate on the outside of a wall. When you are trying to tighten the nut on the bolt which is located within a wall, the wall creates a barrier. Therefore, if the water lines are all located within a wall, then you may have to bust out part of a particular wall in order to get to the faucet. An example of this type of set up would most likely occur in a bath tub area. A bath tub area usually has one or both faucets leading out from the wall. In order to change out this particular faucet, you have to be able to connect to the lines within the wall. This particular configuration in especially popular in countries outside of the United States.

Even changing out a faucet in a sink is somewhat tricky. Generally, there is not a lot of room under the sink, whether kitchen or bathroom, making it very difficult to get to the faucet. Not only do you have to get under the sink but one is at a very odd angle and that is extremely uncomfortable. On top of that, one is trying to get leverage to remove and replace the connections necessary to hold and release the actual faucet.

### SUMMARY OF THE DISCLOSURE

In one embodiment the faucet connection comprises a faucet.

In another embodiment the faucet connection comprises a sleeve.

In yet another embodiment the faucet connection comprises a tap sleeve.

In still another embodiment the sleeve is operable to attach to the tap sleeve on a first end.

In another embodiment the sleeve is operable to attach to a water line on a second end.

In yet another embodiment the tap sleeve is comprised of female thread on the inner side.

In still another embodiment the tap sleeve is operable to attach to the sleeve.

In another embodiment the tap sleeve comprises a ridge located on an upper edge.

In yet another embodiment the

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates a perspective view of a faucet and the tap mate.

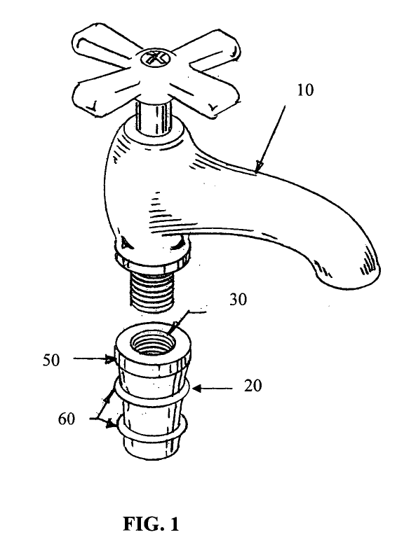

FIG. 2 illustrates a typical water connection device for connecting a faucet to the water line.

FIG. 3 is a detailed view of a tap sleeve described in FIG. 1

FIG. 4 illustrates a typical water connection device used in connection with a tap mate for a mixer faucet.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

FIG. depicts a single faucet 10 which is capable to being attached to a tap sleeve 20. The tap sleeve 20 is comprised of female threads 30 on the inner side and is operable to attach to a sleeve 40. The tap sleeve 20 also has a ridge 50 located on the upper edge and two ridges 50 located on the outer side of the tap sleeve 20 for locating o-rings 60. The o-rings 60 function to seal the tap sleeve 20 which inserted into the sleeve 40. This seal is necessary to prevent leakage around the connection to the faucet 10. Once the o-rings 60 are placed on the tap sleeve 20, the tap sleeve 20 is inserted into the sleeve 40 and connected to the sleeve 40 by using two grub screws 70. The grub screws 70 are inserted into the sleeve 40 and engage with the tap sleeve 20 on its upper edge to hold the two pieces together. The tap sleeve 20 is then connected to the faucet 10 by using the female threads 30 to screw the faucet 10 into the tap sleeve 20. The sleeve 40 is then connected to a water line using a threaded component. Once the connection is complete, then the faucet 10 is ready for operation. In the event, that a need to change the faucet 10 arises, then the faucet 10 can disconnected by releasing the grub screws 70 from the sleeve 40 and then removing the tap sleeve 20. This alleviates the chances of causing damage to the water line in the connection and disconnection of the faucet 10.

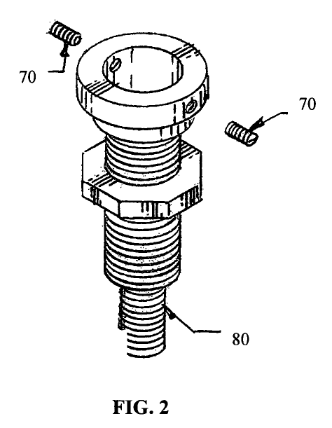

FIG. 2 illustrates a sleeve 40 and more specifically outlines depicts the threaded end 80 which connects to a water line. FIG. 2 also illustrates the openings for inserting the grub screws 70 which engage with the tap sleeve 40.

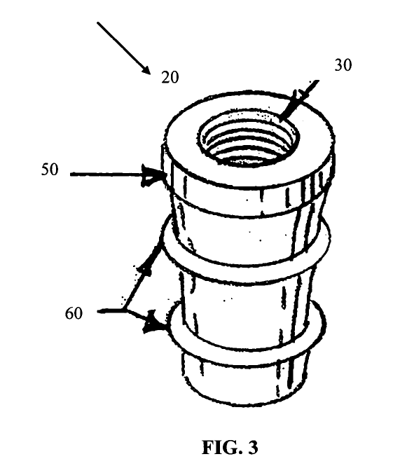

FIG. 3 depicts a tap sleeve 20 and further illustrates the ridge 50 located on the upper edge of the tap sleeve 20. Also illustrates the ridges 50 located on the outer side of the tap sleeve 20 which function to hold the o-rings 60 in a designated area. It is essential to have the o-rings 60 located in this particular area to prevent leaks when the tap sleeve 20 is inserted into the sleeve 40. The female threads 30 which are located on the inner side of the tap sleeve 20 are also illustrated and are used to connect the faucet 10 to the tap sleeve 20.

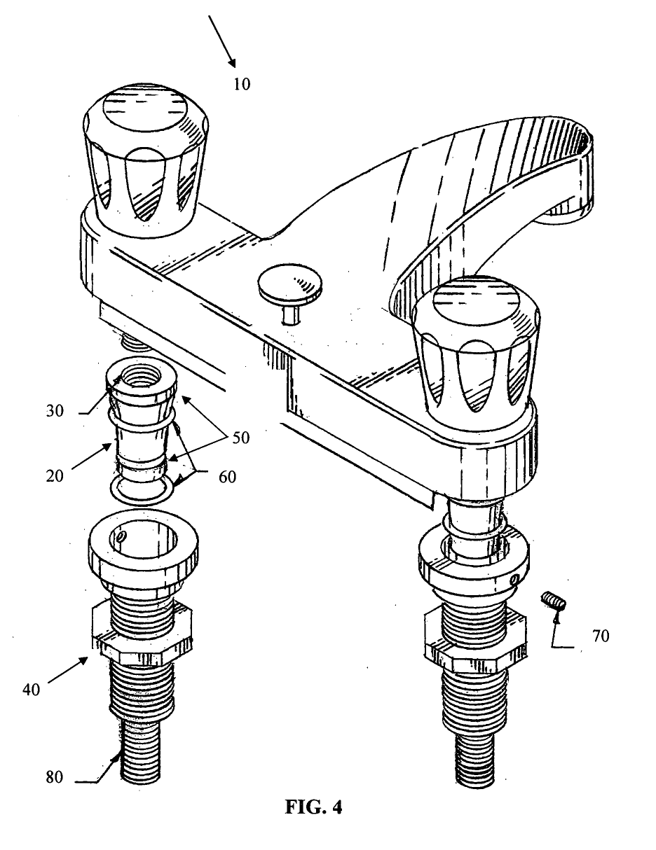

FIG. 4 demonstrates the use of a tap sleeve 20 and a sleeve 40 which attach to a mixer faucet 10. In this particular configuration, the use of two tap sleeves 20 and two sleeves 40 are used so that the faucet 10 is connected to a hot water line and a cold water line. Once the tap sleeve 20 is connected to the sleeve 40 then the hot water handle and the cold water handle function to cause the water to mix and come out a single faucet 10.

In some instances the tap sleeve 20 will actually be inserted into the sleeve 40 when the sleeve 40 is located behind a wall. By having the tap sleeve 20 to perform this connection, the faucet 10 can be replaced as needed without having to cut a hole in the wall. The tap sleeve 20 is designed to be universal in that it will connect any faucet 10 to a typical sleeve 40 which connects to a water line. Therefore, by using the tap sleeve 20 on all faucets 10 connections, the need to cut into a wall for replacement is eliminated.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A faucet connection comprising:
a sleeve operable to attach to a tap sleeve on a first end and attached to a water line on a second end;
tap sleeve comprised of female threads on the inner side and operable to connect to said sleeve;
a ridge located on an upper edge of said tap sleeve and two ridges located on the outer side of said tap sleeve and operable for locating o-rings;
a set of o-rings operable to fit into said ridges on said outer edge of said tap sleeve and operable to prevent leakage; and
two grub screws operable to connect said tap sleeve and said sleeve at said upper edge of said tap sleeve.

2. The faucet connection of claim 1, wherein said tap sleeve is cylindrical in shape.

3. The faucet connection of claim 1, wherein said tap sleeve measures approximately one hundred millimeters in length and between 20 and 50 millimeters in diameter.

4. The faucet connection of claim 1, wherein said tap sleeve comprises ½ inch treads.

5. The faucet connection of claim 1, wherein said tap sleeve comprises ¾ inch threads.

6. The faucet connection of claim 1, wherein said tap sleeve is comprised of a non-corrosive steel or alloys of steel and aluminum.

7. A faucet system comprising:
a faucet; and
a faucet connection for connecting to said faucet including a sleeve operable to attach to a tap sleeve on a first end and attached to a water line on a second end; a cylindrical shaped tap sleeve comprising female threads on the inner side and operable to a connect to a faucet on a first end and said sleeve on a second end; a ridge located on an upper edge of said tap sleeve and two ridges located on the outer side of said tap sleeve operable for locating o-rings; a set of o-rings operable to fit into said ridges on the outer edge of said tap sleeve and operable to prevent leakage; and two grub screws operable to connect said tap sleeve and said sleeve at said upper edge of said tap sleeve.

8. The faucet system of claim 7, wherein said tap sleeve measures approximately one hundred millimeters in length and between 20 and 50 millimeters in diameter.

9. The faucet system of claim 7, wherein said tap sleeve comprises ½ inch treads.

10. The faucet system of claim 7, wherein said tap sleeve comprises ¾ inch threads.

11. The faucet system of claim 7, wherein said tap sleeve is comprised of a non-corrosive steel or alloys of steel and aluminum.

12. A faucet system comprising:
a faucet; and
a faucet connection system including:
a first sleeve operable to attach to a tap sleeve on a first end and attachable to a hot water line on a second end;
a second sleeve operable to attach a tap sleeve on a first end and attachable to a cold water line on a second end;
a cylindrical shaped tap sleeve comprising female threads on the inner side and operable to a connect to a first faucet on a first end and said first sleeve on a second end;
a cylindrical shaped tap sleeve comprising female threads on the inner side and operable to a connect to a second faucet on a first end and said second sleeve on a second end;
a ridge located on an upper edge of said first and second tap sleeves and two ridges located on the outer side of each said tap sleeve operable for locating o-rings;
a set of o-rings operable to fit into said ridges on the outer edge of said first and second tap sleeves and operable to prevent leakage;
two grub screws operable to connect said first tap sleeve and said first sleeve at said upper edge of said first tap sleeve; and
two grub screws operable to connect said second tap sleeve and said second sleeve at said upper edge of said second tap sleeve.

13. The faucet system of claim 12, wherein said first and second tap sleeves measures approximately one hundred millimeters in length and between 20 and 50 millimeters in diameter.

14. The faucet system of claim 12, wherein said first and second tap sleeves comprises ½ inch treads.

15. The faucet system of claim 12, wherein said first and second tap sleeves comprises ¾ inch threads.

16. The faucet system of claim 12, wherein said first and second tap sleeves are comprised of a non-corrosive steel or alloys steel and aluminum.

17. The faucet system of claim 12, wherein said faucet is a mixer faucet operable to mix cold and hot water received from the hot and cold water lines.
